(19) United States
(12) Patent Application Publication
(10) Pub. No.: US 2024/0079744 A1
(43) Pub. Date: Mar. 7, 2024

(54) TRACTION BATTERY PACK TAB TERMINAL PIERCING SYSTEM

(71) Applicant: Ford Global Technologies, LLC, Dearborn, MI (US)

(72) Inventor: Patrick Daniel Maguire, Ann Arbor, MI (US)

(21) Appl. No.: 18/296,390

(22) Filed: Apr. 6, 2023

Related U.S. Application Data
(60) Provisional application No. 63/403,445, filed on Sep. 2, 2022.

(51) Int. Cl. H01M 50/562; H01M 10/0525; H01M 50/566

(52) U.S. Cl. CPC H01M 50/562; H01M 10/0525; H01M 50/566; H01M 2220/20

(57) ABSTRACT

A battery pack system includes a first tab terminal, a second tab terminal joined to the first tab terminal, and at least one point spaced a distance from the first and second tab terminals. The at least one point is configured to pierce at least the first tab terminal when the first tab terminal and the at least one point are shifted relative to each other such that the at least one point contacts the first tab terminal.

### CROSS-REFERENCE TO RELATED APPLICATIONS

This application claims priority to U.S. Provisional Application No. 63/403,445, which was filed on 2 Sep. 2022 and is incorporated herein by reference.

### TECHNICAL FIELD

This disclosure relates generally to electrically disconnecting battery cells within a traction battery pack when certain external loads are applied to the traction battery pack.

### BACKGROUND

A traction battery pack of an electrified vehicle can include groups of battery cells arranged in one or more cell stacks. The battery cells can include terminals, which are typically electrically connected to other terminals, a busbar, or both.

### SUMMARY

In some aspects, the techniques described herein relate to a battery pack system, including: a first tab terminal; a second tab terminal joined to the first tab terminal; and at least one point spaced a distance from the first and second tab terminals, the at least one point configured to pierce at least the first tab terminal when the first tab terminal and the at least one point are shifted relative to each other such that the at least one point contacts the first tab terminal.

In some aspects, the techniques described herein relate to a battery pack system, further including a cross-member that includes the at least one point.

In some aspects, the techniques described herein relate to a battery pack system, further including an aperture in the cross-member, the first and second tab terminals connected to each other and extending through the aperture, the at least one point disposed about a perimeter of the aperture.

In some aspects, the techniques described herein relate to a battery pack system, wherein the at least one point is disposed along at least an inboard side of the aperture with reference to an orientation of the aperture when installed within a vehicle.

In some aspects, the techniques described herein relate to a battery pack system, wherein the cross-member includes a polymer-based material.

In some aspects, the techniques described herein relate to a battery pack system, wherein the at least one point is part of a pointed edge that extends longitudinally.

In some aspects, the techniques described herein relate to a battery pack system, wherein the at least one point is part of a serrated edge.

In some aspects, the techniques described herein relate to a battery pack system, wherein the point is a polymer-based material.

In some aspects, the techniques described herein relate to a battery pack system, wherein the first and second tab terminals are copper or aluminum.

In some aspects, the techniques described herein relate to a battery pack system, wherein the distance is three millimeters or less.

In some aspects, the techniques described herein relate to a battery pack system, wherein the first and second tab terminals each extend from a lithium-ion battery cell.

In some aspects, the techniques described herein relate to a battery pack system, further including a plurality of welds that electrically connect together the first and second tab terminals.

In some aspects, the techniques described herein relate to a battery pack system, wherein the first and second tab terminals are joined together through an intermediate connector.

In some aspects, the techniques described herein relate to a battery pack circuit opening method: providing a cell stack having a first battery cell with a first tab terminal and a second battery cell with a second tab terminal, the first tab terminal joined to the second tab terminal; and positioning at least one point adjacent to the first tab terminal and the second tab terminal, the at least one point configured to pierce at least the first tab terminal when the first tab terminal and the at least one point shift relative to each other such the first tab terminal and the at least one point contact each other.

In some aspects, the techniques described herein relate to a battery pack circuit opening method, wherein the first tab terminal shifts toward the at least one point in response to a load applied to the cell stack.

In some aspects, the techniques described herein relate to a battery pack circuit opening method, wherein the first tab terminal is joined to the second tab terminal using at least one weld.

In some aspects, the techniques described herein relate to a battery pack circuit opening method, wherein piercing at least the first tab terminal opens an electrical circuit that extends through the first tab terminal and the second tab terminal when the first tab terminal is joined to the second tab terminal.

In some aspects, the techniques described herein relate to a battery pack circuit opening method, wherein a first section of the first tab terminal is configured to completely separate from a second section of the first tab terminal in response to the piercing and the shifting.

In some aspects, the techniques described herein relate to a battery pack circuit opening method, wherein the first and the second tab terminal extend through at least one aperture in a cross-member of a battery pack, the at least one point disposed on the cross-member.

In some aspects, the techniques described herein relate to a battery pack circuit opening method, wherein the shift moves the cell stack relative to the cross-member.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle.

FIG. 2 illustrates an expanded, perspective view of a battery pack from the electrified vehicle of FIG. 2 according to an exemplary embodiment of the present disclosure.

FIG. 3 illustrates a perspective view of a portion of the battery pack of FIG. 2 with the enclosure assembled and with areas cut away to show an outboard region of cross-members.

FIG. 4 illustrates a perspective view of a battery cell from the battery pack of FIG. 2.

FIGS. 5A-5E illustrate perspective views of apertures in one of the cross-members of FIG. 4 showing stages of the tab terminals being received in the apertures and then severed by at least one point.

FIG. 6A illustrates a perspective view of a cross-member according to another exemplary embodiment.

FIG. 6B illustrates a section view taken at line 6B-6B in FIG. 6A.

### DETAILED DESCRIPTION

This disclosure details exemplary systems within a traction battery pack that can electrically disconnect one or more battery cells when external loads, such as a side load, are applied to the traction battery pack.

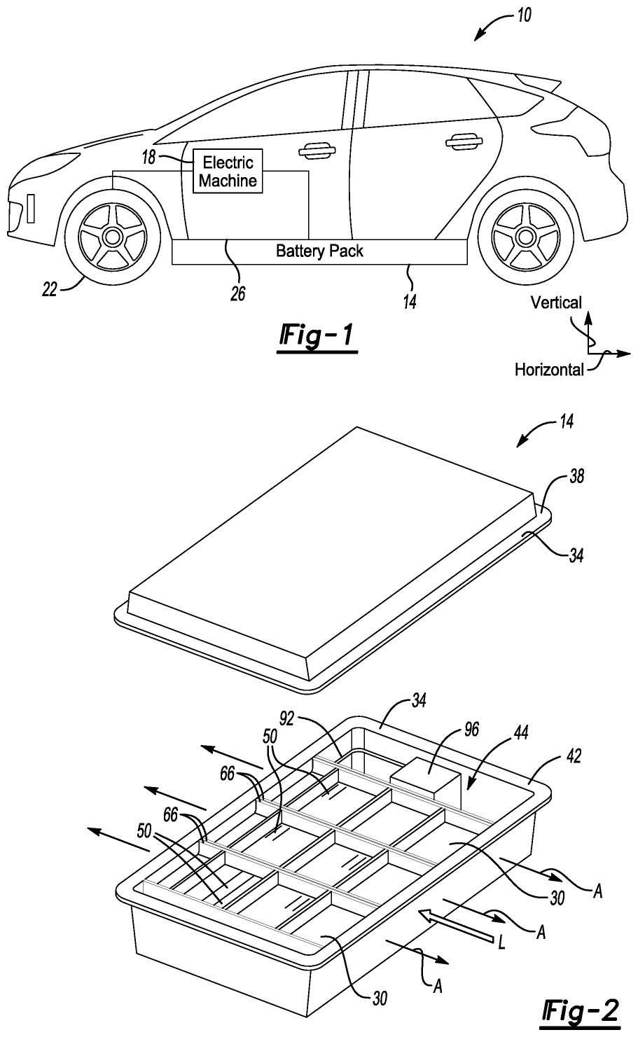

With reference to FIG. 1, an electrified vehicle 10 includes a battery pack 14, an electric machine 18, and wheels 22. The battery pack 14 powers an electric machine 18, which can convert electrical power to mechanical power to drive the wheels 22.

The battery pack 14 is, in the exemplary embodiment, secured to an underbody 26 of the electrified vehicle 10. The battery pack 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a battery pack.

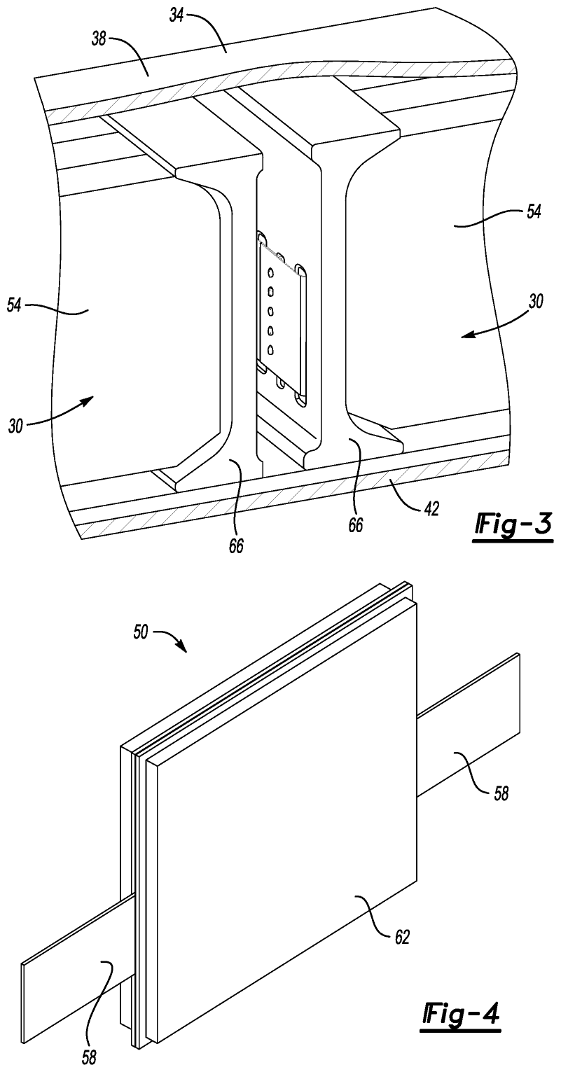

With reference now to FIGS. 2-4, the battery pack 14 includes a plurality of cell stacks 30 held within an enclosure assembly 34. In the exemplary embodiment, the enclosure assembly 34 includes an enclosure cover 38 and an enclosure tray 42. The enclosure cover 38 can be secured to the enclosure tray 42 to provide an interior area 44 that houses the cell stacks 30. The enclosure cover 38 can be secured to the enclosure tray 42 using mechanical fasteners (not shown), for example.

In the exemplary embodiment, each of the cell stacks 30 includes a plurality of battery cells 50 (or simply “cells”). The battery cells 50 are stacked side-by-side relative to each other along the cell stack axis A. Plates 54 can be positioned at opposing ends of the cell stacks 30.

The battery cells 50 store and supply electrical power. Although a specific number of the cell stacks 30 and cells 50 are illustrated in the various figures of this disclosure, the battery pack 14 could include any number of the cell stacks 30 each having any number of individual cells 50.

In an embodiment, the battery cells 50 are lithium-ion pouch-style battery cells. However, battery cells having other geometries (cylindrical, prismatic, etc.), other chemistries (nickel metal hydride, lead acid, etc.), or both could be alternatively utilized within the scope of this disclosure. The exemplary battery cells 50 include tab terminals 58 extending from a battery cell housing 62. An aluminum film can provide at least part of the housing 62, for example. The housing 62 could additionally include a polymer. For each example battery cell 50, one of the terminals 58 may be copper with an anti-corrosion finish and the other may be aluminum.

The battery pack 14 includes a plurality of cross-members 66 that are configured to transfer a load applied to an outboard side of the vehicle 10 and the battery pack 14, for example. The cross-members 66 are disposed between the cell stacks 30. In this example, the cross-members 66 extend longitudinally in a cross-vehicle direction. The cross-members 66 can enhance the structural integrity of the battery pack 14. The cross-members 66 can additionally help to handle tension loads from cell expansion and compression loads.

The cross-members 66 are composite in this example. The cross-members 66 can primarily incorporate a polymer-based material. The cross-members 66 can be pultruded cross-members, which implicates structure to the cross-members 66. The skilled person would understand how to structurally distinguish a pultruded cross-member from another type of cross-member, such as an extruded cross-member.

The cross-members 66 could be made with pultrusion process with continuous fiber glass, carbon or basalt with a thermoset resin. The cross-members 66 can include a plurality of glass strands that are pulled through a thermoset resin. Portions of the cross-member 66 can then be overmolded to provide a desired cross-section.

The cross-member 66 could instead be injection molded or compression molded with glass, carbon or basalt fibers and a thermoplastic resin. In such examples, the cross-member 66 can include a structural element made from extruded aluminum or rolled steel, which is overmolded with a polymer-based material to make a final assembly.

Within the battery pack 14, the tab terminals 58 of battery cells 50 extend from a first side of the cross-member 66 through apertures 70 in the cross-member 66. Groups of the tab terminals 58 are then joined together on an opposite, second side of the cross-member 66.

In this example, terminals 58 from groups of four battery cells 50 are joined to each other. The tab terminals 58 each extend through a respective aperture 70 in the cross-member 66, are folded, and joined by together by welds 80 on the second side of the cross-member 66. In this example, the tab terminals 58 are welded directly to each other. In another example, the tab terminals 58 are each secured (e.g., via welds) to a different area of an intermediate conductor, such as a busbar, to join together the terminals 58. Joining the tab terminals 58 electrically connects together the tab terminals 58.

The cross-members 66 include apertures 70 along a length of the cross-member 66 to receive respective terminals 58 from all the cells 50 of the associated cell stack 30.

In some examples, the tab terminals 58 connect to sense leads, busbars, or both. The sense leads and busbars can be mounted to the cross-members 66 using heat stakes for example. The sense leads and busbars can provide a backer when welding together the tab terminals 58. If a sense lead or busbar is no included, the backer for welding could be provided by a backing plate.

Within the battery pack 14, current can flow along a path that extends through the tab terminals 58 that are joined together. An electrical circuit thus extends through the tab terminals 58 that are joined together. From time-to-time, forces resulting from an external load, such as an side load, may be applied to the vehicle 10 and the battery pack 14. A system of the example battery pack 14 helps to open the electrical circuit in response to certain external loads. The system opens the electrical circuit by severing one or more of the tab terminals 58 in response to the external load.

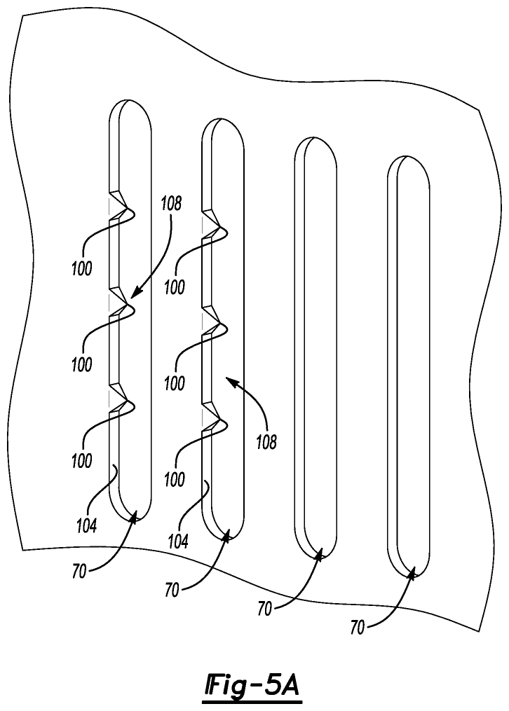

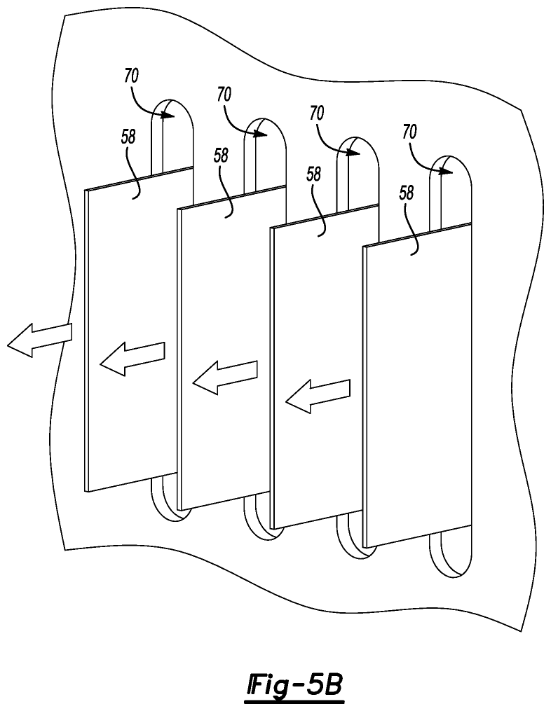

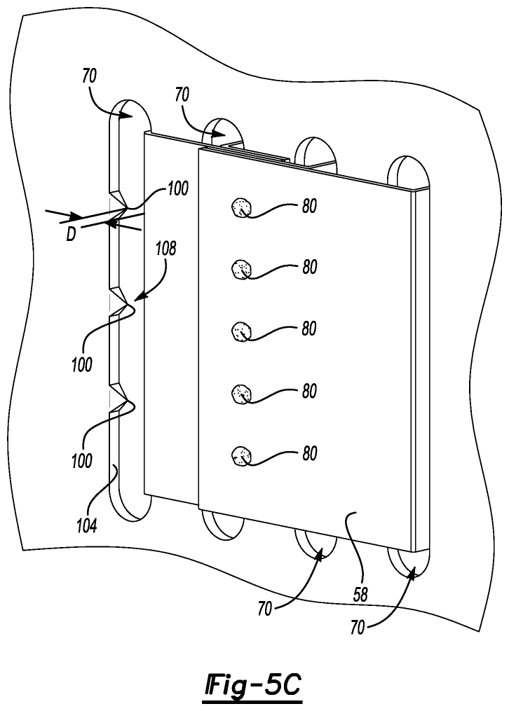

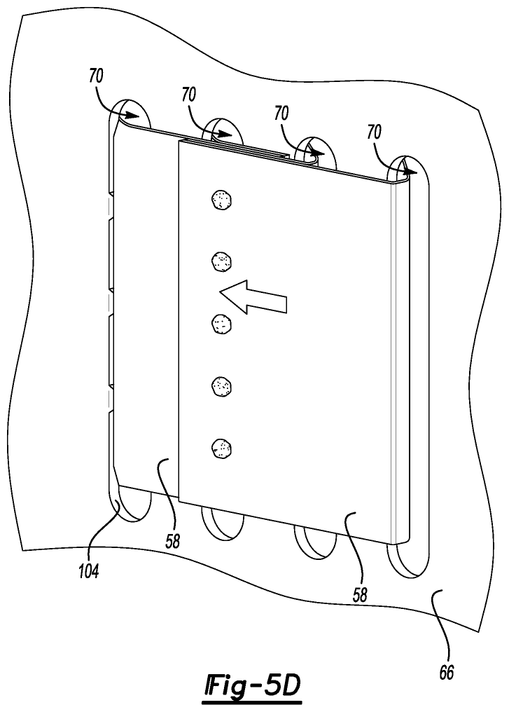

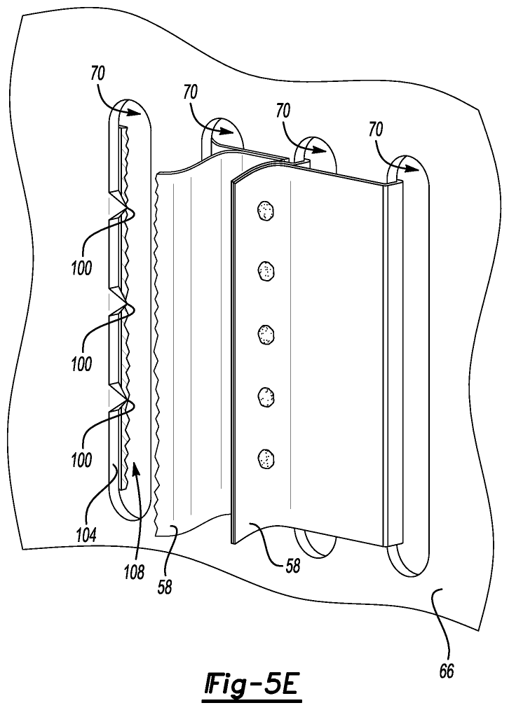

As shown in FIGS. 5A, the battery pack 14 incorporates at least one point 100. In this example, the cross-members 66 provide the at least one point 100. After the tab terminals 58 have been inserted into the apertures 70 as showing in FIG. 5B, and then folded and secured together with welds 80 as shown in FIG. 5C, the at least one point 100 is spaced a distance from at least one of the tab terminals 58. The at least one point 100 is configured to pierce at least one of the tab terminals 58 when the at least one point 100 and the at least one tab terminal 58 are shifted relative to each other.

In this example, the at least one point 100 is included on one of the cross-members 74. More specifically, the at least one point 100 is disposed about a perimeter of one of the apertures 70 along at least an inboard side 104 of the aperture 78. Inboard is with reference to an orientation of the aperture 78 when the battery pack 14 is installed within the vehicle 10.

In this example, the at least one point 100 includes three points about a perimeter of the aperture 70 on the inboard side 104. The three points 100 provide a serrated edge 108. The adjacent aperture 70 has three points 100 about its perimeter.

Only two of the four apertures 70 include the points 100 in this example. In another example, all the apertures 70 or some other number of the apertures 70 could include the points 100.

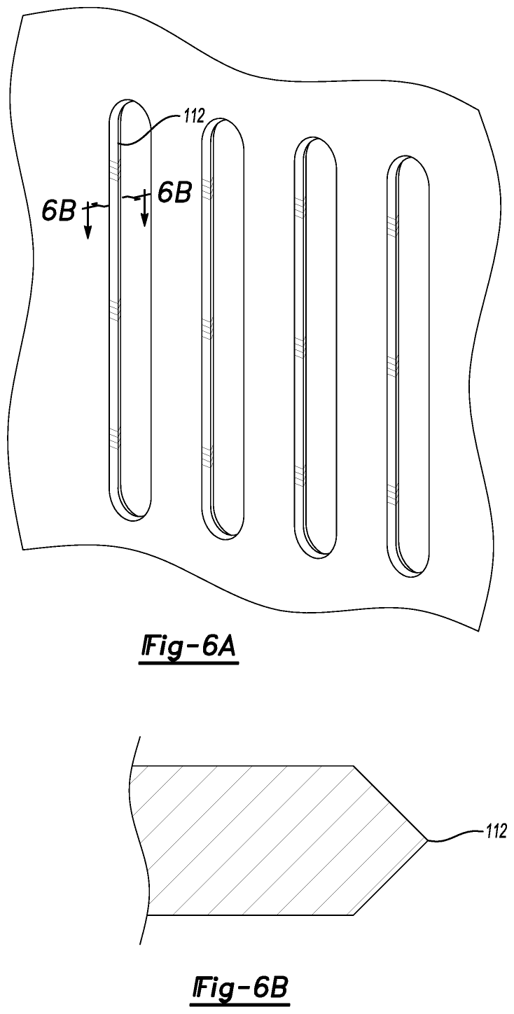

In another example, the at least one point is provided by of a pointed edge 112 that extends longitudinally as shown in FIGS. 6A and 6B. The pointed edge 112 can be considered a knife-edge.

With reference again to FIG. 5C, the at least one point 100 is adjacent the tab terminals 58. The distance between the tab terminal 58 and the at least one point is about three millimeters. This space is maintained during ordinary operation of the battery pack 14 and vehicle 10. The spacing could be less than three millimeters in some examples.

When a certain load is applied to the vehicle 10, such an external load L shown with an arrow in FIG. 2, the cell stack 30 shifts relative to the at least one point 100 as shown in FIG. 5D. This causes the at least one point 100 to contact and then pierce the tab terminals 58 until the tab terminals 58 are severed as shown in FIG. 5E. Severing results in a portion of the tab terminals 58 completely separating from another portion of the tab terminals 58. Severing the tab terminals 58 opens the electrical circuit extending through the tab terminals 58. This can electrically isolate the battery cells 50 having those tab terminals 58 and limit exposure to high voltages after the external load.

The external load L can result from a pole contacting a side of the vehicle 10. The shift of the cell stack 30 relative to the cross-member 66 generally occurs when the external load L is directed at an axial end of the cell stack 30 rather than an axial end of the cross-member 66.

The at least one point 100 is disposed on the inboard side of the aperture 78 as the tab terminals 58, in this example, are most likely to move relatively toward the inboard side in response to the load L. In other examples, the at least one point 100 could instead or additionally be outboard the tab terminals 58, above the tab terminals 58, below the tab terminals 58, or some combination of these. A position of the at least one point 100 relative to the tab terminals 58 can be selected based on the type of relative movement expected in response to the load.

Although shown on the cross-member 66, the at least one point 100 could instead or additionally be incorporated elsewhere, such as within the busbar or sense lead. For example, the tab terminals 58 could be secured to a busbar that is heat staked to the cross-member 66. The busbar could be machined to include a serrated edge that provides at least one point that severs the tab terminals 58 when they shift relative to the busbar and cross-member 66.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A battery pack system, comprising:
a first tab terminal;
a second tab terminal joined to the first tab terminal; and
at least one point spaced a distance from the first and second tab terminals, the at least one point configured to pierce at least the first tab terminal when the first tab terminal and the at least one point are shifted relative to each other such that the at least one point contacts the first tab terminal.

2. The battery pack system of claim 1, further comprising a cross-member that includes the at least one point.

3. The battery pack system of claim 2, further comprising an aperture in the cross-member, the first and second tab terminals connected to each other and extending through the aperture, the at least one point disposed about a perimeter of the aperture.

4. The battery pack system of claim 3, wherein the at least one point is disposed along at least an inboard side of the aperture with reference to an orientation of the aperture when installed within a vehicle.

5. The battery pack system of claim 2, wherein the cross-member comprises a polymer-based material.

6. The battery pack system of claim 1, wherein the at least one point is part of a pointed edge that extends longitudinally.

7. The battery pack system of claim 1, wherein the at least one point is part of a serrated edge.

8. The battery pack system of claim 1, wherein the point is a polymer-based material.

9. The battery pack system of claim 1, wherein the first and second tab terminals are copper or aluminum.

10. The battery pack system of claim 1, wherein the distance is three millimeters or less.

11. The battery pack system of claim 1, wherein the first and second tab terminals each extend from a lithium-ion battery cell.

12. The battery pack system of claim 1, further comprising a plurality of welds that electrically connect together the first and second tab terminals.

13. The battery pack system of claim 1, wherein the first and second tab terminals are joined together through an intermediate connector.

14. A battery pack circuit opening method:
providing a cell stack having a first battery cell with a first tab terminal and a second battery cell with a second tab terminal, the first tab terminal joined to the second tab terminal; and
positioning at least one point adjacent to the first tab terminal and the second tab terminal, the at least one point configured to pierce at least the first tab terminal when the first tab terminal and the at least one point shift relative to each other such the first tab terminal and the at least one point contact each other.

15. The battery pack circuit opening method of claim 14, wherein the first tab terminal shifts toward the at least one point in response to an external load applied to the cell stack.

16. The battery pack circuit opening method of claim 14, wherein the first tab terminal is joined to the second tab terminal using at least one weld.

17. The battery pack circuit opening method of claim 14, wherein piercing at least the first tab terminal opens an electrical circuit that extends through the first tab terminal and the second tab terminal when the first tab terminal is joined to the second tab terminal.

18. The battery pack circuit opening method of claim 14, wherein a first section of the first tab terminal is configured to completely separate from a second section of the first tab terminal in response to the piercing and the shifting.

19. The battery pack circuit opening method of claim 14, wherein the first and the second tab terminal extend through at least one aperture in a cross-member of a battery pack, the at least one point disposed on the cross-member.

20. The battery pack circuit opening method of claim 19, wherein the shift moves the cell stack relative to the cross-member.
